(19) United States
(12) Patent Application Publication
(10) Pub. No.: US 2015/0348530 A1
(43) Pub. Date: Dec. 3, 2015

(54) Noise Masking in Headsets

(71) Applicant: Plantronics, Inc., Santa Cruz, CA (US)

(72) Inventors: Benedict Andrew Findlay, Swindon (GB); Evan Harris Benway, Santa Cruz, CA (US); Ken Kannappan, Palo Alto, CA (US); John S. Graham, Scotts Valley, CA (US)

(73) Assignee: Plantronics, Inc., Santa Cruz, CA (US)

(21) Appl. No.: 14/293,901

(22) Filed: Jun. 2, 2014

(51) Int. Cl. G10K 11/178; G10L 21/0208; H04R 5/033; H04R 3/12; H04R 5/04; H04S 7/00; G10L 21/0216

(52) U.S. Cl. CPC G10K 11/1786; H04S 7/304; G10L 21/0208; G10L 21/0216; H04R 3/12; H04R 5/04; H04R 5/033; G10L 2021/02165

(57) ABSTRACT

Methods and apparatuses for addressing open space noise are disclosed using both dynamic and static sound masking. In one example, an adaptive sound masking system and method portions undesired sound into time-blocks and estimates frequency spectrum and power level, and continuously generates masking noise with a matching or predetermined spectrum and loudness or power level to mask the undesired sound. In another example, a static sound masking system and method portions undesired sound into time-blocks and estimates frequency spectrum and power level, and generates a static noise-masking signal with a matching spectrum and power level to mask the undesired sound.

### FIELD

Embodiments of the invention relate to systems and methods for wearable technologies and noise reduction. More particularly, an embodiment of the invention relates to systems and methods that facilitate psycho-acoustic audio processing on devices such as headsets.

### BACKGROUND

Noise within an open space can be problematic for people working within its confines. For example, many office buildings utilize a large open plan office area in which employees work in cubicles with low cubicle walls or at workstations without any acoustical barriers.

Random dynamic noise, and in particular speech noise, is the top complaint of office workers about their offices, especially those working in open plan offices. One reason for this is that speech enters readily into the brain's working memory and is therefore highly distracting. Even speech at very low levels can be highly distracting when ambient noise levels are low (as in the case of someone answering a telephone call in a library). Examples of random dynamic noise apart from speech includes keyboard noises, phones ringing, doorbells or other noises that come and go. These random dynamic noises differ substantially from general background static noise in that they are unintentionally “interesting” to a person's subconscious, and so cause interruption and distraction.

Productivity losses due to speech noise have been shown in peer-reviewed laboratory studies to be as high as 41%. Office acoustic design has made strides in reducing ambient noise, but the quiet environments that have been created can cause speech noise to contrast strongly against the quiet. Thus, even quiet offices, can create a level of speech intelligibility that is highly distracting. The intelligibility of speech can be measured using the Speech Transmission Index (“STI”).

Open office noise is often described by workers as unpleasant and uncomfortable. Speech noise, printer noise, telephone ringer noise, and other distracting sounds increase discomfort. These problems are becoming increasingly important as office worker density accelerates. The higher the utilization of office space, the more acoustical problems come to the fore. This discomfort can be measured using subjective questionnaires as well as objective measures, such as cortisol levels.

In one body of prior art, the issues associated with office noise have been attacked by facilities engineers. Noise absorbing ceiling tiles, carpeting, screens, furniture, and so on, have become the standard and office noise has been substantially decreased. Because of their dynamic nature, the random noises are not possible to “cancel out” with conventional noise cancelling systems. They are also often louder than traditional static white noise would mask. The frequency characteristics are also completely unpredictable and changing.

A key limitation on conventional ceiling-based noise masking systems, for example, is that even with the most highly effective system, the technology can only reduce the radius of distraction from dynamic noise to a point. Even with an excellently designed system in a well-planned office space, a conversation from an adjacent desk is likely to be highly distracting.

Reducing noise levels alone does not completely solve the problems described above, as they relate to sounds that tend to distract humans somewhat regardless of their intensity. Random noise intelligibility can be unaffected, or even increased, by the noise reduction measures of facilities professionals.

Another type of prior art solution comprises injecting a pink noise or filtered pink noise (herein referred to simply as “pink noise”) into the open office. Pink noise is effective in reducing random noise intelligibility and increasing acoustical comfort. However, listeners complain that pink noise sounds like an airplane environment, or complain that the constant air conditioning like sound of the pink noise itself becomes fatiguing over time.

A third avenue found in the prior art with respect to reducing the noise pollution within open plan office environments comprises wearable products. For example, sound occlusion may be obtained using large circumaural headphones that physically block out sounds. These devices tend to be large, cumbersome, and uncomfortable. These devices may achieve some success in blocking sounds but they have other limitations as discussed, and they also suffer from serious drawbacks as well. Conventional active noise cancellation provides another prior art solution along a similar vein. In active noise cancellation, electronics drive speaker elements with well-defined anti-phase noise, to actively cancel sound. Such prior art systems are often very good at low frequencies (sub 2 KHz), with static noise, and they are nearly ideal in aircraft. However, active noise cancellation systems do not improve on the distraction, as both steady state noise and vocalized speech elements are equally affected, and active noise cancellation systems do not work with the higher frequencies of speech sibilance, where speech intelligibility is most important.

In light of the prior art, providing an optimal solution to the problem of dynamic noise in the workplace, especially in open plan offices, particularly calls for improved methods and apparatuses for addressing open space noise.

### SUMMARY OF THE INVENTION

Embodiments of the invention provide a system a system for masking distracting sounds in a headset. The system includes a microphone in the headset that detects sounds, including distracting sounds. The system also includes a signal processor that identifies distracting sounds detected by the microphone and generates a noise-masking signal. The system further includes two speakers in the headset that receive the noise-masking signal from the signal processor and play the noise-masking signal.

Embodiments of the invention also provide a system for masking distracting sounds in a headset. The system includes a noise-masking device that generates a stereo noise-masking signal. The system also comprises an audio transmitter that outputs a monotone audio signal. The system further includes a mixer that combines the stereo noise-masking signal and the monotone audio signal to produce a combined output signal. The system also includes two speakers in the headset that receive the combined output signal from the mixer and play the combined output signal.

Embodiments of the invention provide a method for masking distracting sounds in a headset. The method comprises detecting sounds in a microphone in the headset, including distracting sounds. The method also includes identifying distracting sounds in a signal processor from the detected sounds by the microphone and generating a noise-masking signal. The method further comprises receiving the noise-masking signal in a pair of speakers in the headset from the signal processor and playing the noise-masking signal.

Embodiments of the invention also provide a method for masking distracting sounds in a headset. The method comprises generating a stereo noise-masking signal by a noise-masking device. The method includes outputting a monotone audio signal by an audio transmitter. The method further comprises combining the stereo noise-masking signal and the monotone audio signal by a mixer to produce a combined output signal. The also includes receiving the combined output signal from the mixer in two speakers in the headset that play the combined output signal.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a dynamic noise-masking system 100 embodied in a headset 102, according to an embodiment of the invention.

FIG. 2 illustrates a block diagram for a dynamic noise-masking system 200 incorporated into a headphone 201, according to an embodiment of the invention.

FIG. 3 provides a flowchart 300 for a dynamic noise masking system in a headphone, according to an embodiment of the invention.

FIG. 4 illustrates a static noise-masking system 400 included in a headset 402, according to an embodiment of the invention.

FIG. 5 provides a stylized view of how each speaker 505a, 505b outputs a cloud 502a, 502b of stereo masking sounds 503a, 503b while the call signals 501a, 501b are output in monotone, according to an embodiment of the invention.

FIG. 6 provides a flowchart 600 that illustrates the operations of static noise-masking system, in a headphone, according to an embodiment of the invention.

FIG. 7 illustrates a block diagram for a static noise-masking system 700 incorporated into a headphone 701, according to an embodiment of the invention.

FIG. 8 illustrates a noise-masking system 800 that includes a head-tracking unit 803 in a headset 801, according to embodiment of the invention.

FIG. 9 illustrates a flowchart 900 that provides a noise masking algorithm such as one that could be employed by a signal processor, such as the DSP 208 shown in FIG. 2, according to an embodiment of the invention.

FIG. 10A illustrates a noise-masking system 1000 that comprises a static noise-masking device 1014 in a headset 1001, according to embodiment of the invention.

FIG. 10B illustrates a noise masking system 1020 that comprises a static noise-masking device 1017 in a computer 1025 connected to a headset 1003, according to embodiment of the invention.

FIG. 11 provides a flowchart 1100 for a static noise masking system in a headphone, such as the headphone 1101 shown in FIG. 10A and the headphone 1103 shown in FIG. 10B, according to an embodiment of the invention.

### DETAILED DESCRIPTION OF AN EMBODIMENT OF THE INVENTION

Embodiments of the invention provide noise masking in a headset or headphone. Some embodiments of the invention pertain to dynamic or adaptive noise masking while other embodiments of the invention provide static noise masking. Headsets and headphones are used interchangeably for embodiments of the invention.

Embodiments of the invention may help solve at least two problems in headphones that can be defined as speech intelligibility and acoustical comfort.

As previously discussed, office noise, and in particular speech noise, is a top complaint of office workers about their offices. Office acoustic design has improved at reducing ambient noise, but the quiet environments that have been created cause speech noise to contrast strongly with the otherwise quiet environment. Even quiet offices, therefore, can create levels of speech intelligibility that are highly distracting.

In terms of acoustical comfort, open office noise is typically described by workers as unpleasant and uncomfortable. Speech noise, printer noise, telephone ringer noise, and other distracting sounds increase discomfort. This discomfort can be measured using subjective questionnaires as well as objective measures, such as cortisol levels.

With regards to acoustical comfort, there is more to this issue than unwanted noise. Conventional masking systems are unable to reach masking levels of much more than 48 dB because anything more powerful becomes uncomfortable. Additionally, conventional masking systems tend to use a filtered pink noise (closer to brown noise after penetrating the ceiling tiles) that is often less effective than white noise at reducing sentence intelligibility, but which is also more comfortable to the typical human ear. People react strongly to noise introduced into their environments, and their subjective comfort is therefore an extremely important consideration in designing masking products that people will want to use.

Thus, embodiments of the invention aim to make headsets better at reducing noise distraction. Embodiments of the invention are applicable to binaural headsets or headphones. To be clear, embodiments of the invention aim to reduce ambient speech intelligibility while having no detrimental impact on headset audio speech intelligibility.

In one embodiment, an adaptive sound masking system and method portions undesired sound into time-blocks and estimates frequency spectrum and power level, and continuously generates a masking noise with a matching spectrum and power level to mask the undesired sound. In another embodiment, a static sound masking system and method portions undesired sound into time-blocks and estimates frequency spectrum and power level, and generates a static noise-masking signal with a matching spectrum and power level to mask the undesired sound. In still another embodiment, a static sound masking system and method generates a user-controlled noise-masking signal that operates according to user desired masking requirements.

In some embodiments of the invention, the noise-masking signal has a predefined spectrum and power level, and these control elements may be controlled by a user-adjustable level. Thus, the final masking sound may be static, but the noise-masking signal is only generated after an analysis of the ambient noise. In short, the initialization is “dynamic” to create an appropriate noise-masking signal, but the parameters of the noise masking signal are static thereafter, according to an embodiment of the invention. As noted, in still other embodiments, the masking signal is user controlled and not directly related to distracting ambient noises.

Some embodiments of the invention employ a signal processor (e.g., a digital signal processor) to accomplish noise masking. However, the noise mask need not be generated digitally—some embodiment of the invention employ devices that generate the masking noise in an analogue manner.

In some embodiments of the invention, a stereo noise masking signal is combined with a mono call signal to produce a combined signal that masks distracting ambient noise while not obscuring voice data from the call signal.

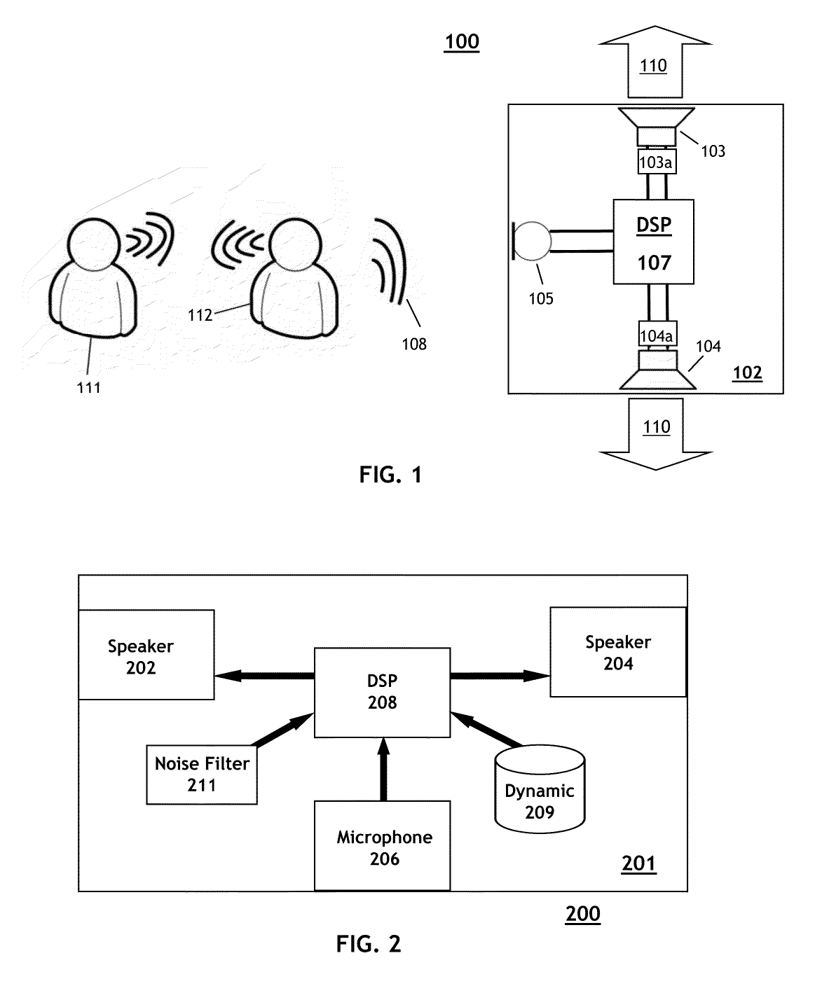

FIG. 1 illustrates a dynamic noise-masking system 100 embodied in a headset 102, according to an embodiment of the invention. The dynamic noise-masking system 100 generates a masking noise (e.g., a “wide spectrum” noise that can resemble filtered brown noise or pink noise) that adapts to its surrounding environment. The dynamic noise-masking system 100 provides a masking noise comprised of pink noise, brown noise, and/or some similar combination (e.g., including natural sounds such as water noise) and generally avoids providing pure white noise, as this can be unpleasant to many users, according to an embodiment of the invention.

The headset 102 includes at least one microphone 105 that listens to the environment for distracting sounds 108 that pass a particular threshold. The distracting sounds 108 here have been generated by the activities of persons 111-112, neither of whom is wearing the headset 102. The threshold can be set at a predetermined level, and in some embodiments may be set by the user. The microphone 105 passes a signal for detected sounds to digital signal processor (DSP) 107 that has been particularly tuned to detect sounds 108 that are highly distracting, e.g., human speech. The headset 102 may include more than one microphone, and in such cases the DSP 107 may need alteration to accommodate multiple microphones.

When the DSP 107 detects a sound at a level judged to be distracting, then the DSP 107 generates a noise-masking signal 110 tailored to block the incoming distracting sound 108, according to an embodiment of the invention.

The DSP 107 generates the noise-masking signal 110 in a way that is pleasant and non-disruptive, according to an embodiment of the invention. Speakers 103, 104 in the headset 102 play the noise-masking signal 110 to the headset wearer, according to an embodiment of the invention. The speakers 103, 104 may have a driver 103a, 104a that controls or directs the sound output of the speaker 103, 104, according to an embodiment of the invention.

The DSP 107 may include active noise cancellation (“ANC”) capabilities, according to an embodiment of the invention. In such embodiments, the ANR may necessitate a different masking spectrum than a DSP not having an ANR capability and/or level and both levels might be adjusted accordingly, by the user and/or the DSP 107.

As the distracting sound 108 increases (e.g., a speaking person moves closer to the headset 102), the DSP 107 increases the noise-masking signal 110, following the amplitude and frequency response of the distracting sound 108. The DSP 107 produces the noise-masking signal 110 with a wider broad band spectrum (e.g., a wide spectrum noise), at a level just required to block the distracting sound 108, according to an embodiment of the invention.

The noise-masking signal 110 generated by the DSP 107 comprises a masking noise, in the sense that the noise-masking signal 110 would be wide-spectrum noise, random, with no useful content, and not distracting, according to an embodiment of the invention. The whitish noise comprises either pink noise, brown noise, or a combination of the two, according to an embodiment of the invention.

Thus, the noise-masking signal 110 is specifically tailored by the DSP 107 to cover the frequencies required to block the background sound, according to an embodiment of the invention.

The noise-masking signal 110 essentially replaces a meaningful (but unwanted) sound (e.g., human speech) with a useless (and hence less distracting) noise, the noise-masking signal 110. The DSP 107 automatically fades the noise-masking signal 110 back down to silence when the ambient noise abates (e.g., when the distracting sound 108 ends), according to an embodiment of the invention.

A wearer of the headset 102 hears something like waves crashing in the ocean or wind in the trees (e.g., both representing the noise-masking signal 110), instead of someone talking (e.g., the distracting sound 108), according to an embodiment of the invention. The DSP 107 ensures that the noise-masking signal 110 remains dynamic and changes as needed, but would not take someone's attention away, according to an embodiment of the invention. In another embodiment of the invention, the wearer of the headset 102 does not hear a sound like waves or winds but instead find the distracting sound 108 reduced, as the rate of level change would, in such an embodiment, be so slow as to be imperceptible to the average user, but fast enough to account for significant changes in level throughout the day.

The DSP 107 ensures that the noise-masking signal 110 remains dynamic and changes as needed, but also ensures that the noise-masking signal 110 does not take away the attention of the wearer of the headset 102, according to an embodiment of the invention.

While the noise-masking signal 110 may be controlled by DSP 107, the noise-masking signal 110 itself can be generated in a number of ways, including analogue white noise that is filtered to have the desired (brown/pink) spectrum, according to an alternative embodiment of the invention.

The noise-masking system 100 could be implemented in many models of the headset 102, according to an embodiment of the invention. For example, the noise-masking system 100 could employ existing microphones in a headset. In other words, the microphone 105 could be an existing microphone in the headset 102 rather than comprising an added microphone. As mentioned above, the headset 102 may use more than one microphone. Similarly, the DSP 107 could be a DSP already resident in the headset 102, according to an embodiment of the invention. Likewise, the speakers 103, 104 could be speakers already resident in the headset 102 and would not necessarily need to be new speakers, according to an embodiment of the invention.

Embodiments of the invention may be particularly applicable to binaural headsets but the headsets would not necessarily need to be occluding or large.

The noise-masking signal 110 may be implemented in a multi-driver system in which one speaker (e.g., the speaker 103) delivers the noise-masking signal 110 while another speaker (e.g., the speaker 104) delivers something else (e.g., speech), according to an embodiment of the invention. In such an embodiment, the driver 103a differs from the driver 104a, according to an embodiment of the invention. Some headphones may employ a “woofer/tweeter” setup with multiple drivers. Thus, the speakers 103, 104 can employ one or more drivers 103a, 104a with either noise-masking sound 110 and telecom speech combined, or divided between the drivers 103a, 104a, according to an embodiment of the invention.

In an alternative embodiment of the invention, the speakers 103, 104 may be joined by additional speakers, according to an embodiment of the invention. Depending upon the specific hardware employed in a headset, it is not always easy to mix audio from two different sources, especially when the sample rate of the audio is different. In addition, a larger form factor headset also simplifies the use of more than one driver. Extra speakers can sometimes be less expensive than adding additional processing components in a headset. Such embodiments have already been employed for some surround sound headset/headphone systems.

The noise-masking system 100 may provide an always-on noise-masking system in the headset 102 so that the headset 102 could be worn all day to block out distracting noise. The noise-masking system 100 could be active regardless of whether the headphones 102 were in use for another purpose, but would adapt to the situation for music or telephone calls, according to an embodiment of the invention.

The DSP 107 may be set to decrease the noise-masking signal 110 when the user removes the headset 102 and increase the noise-masking signal 110 at a defined rate when the headset 102 is re-donned by the user, so as not to be jarringly obvious to the user, according to an embodiment of the invention.

Individual workers wearing headsets 102 should find their environment more relaxing, calming and efficient. These workers may also be more productive, with fewer interruptions and less stress.

Individual workers may enjoy their headsets 102 and actively choose to wear them, even without wanting to listen to music or phone calls, simply to improve their working conditions. Thus, the headsets 102 become something desirable in their own right.

The DSP 107 need not necessarily be located on the headset 102. The DSP 107 could be located on another device (e.g., a computer) with the relevant signals transmitted to/from the headset to the computer and vice versa, e.g., over a USB cable, according to an embodiment of the invention.

In addition, the DSP 107 could be an analog signal processor. A digital signal processor is not strictly required, although a DSP represents one hardware element that could be employed in an embodiment of the invention. In short, a signal processor of various types could be used in many embodiments of the invention.

FIG. 2 illustrates a block diagram for a dynamic noise-masking system 200 incorporated into a headphone 201, according to an embodiment of the invention.

The headphone 201 includes at least one microphone 206. As discussed in conjunction with FIG. 1, the microphone 206 may be a conventional microphone. The microphone 206 detects environmental sounds and forwards them to a digital signal processor 208. Not all of the sounds detected by the microphone 206 will necessarily be distracting sounds. The headphone 201 may include more than one microphone 206, and in such cases the DSP 208 may need minor adjustments to accommodate multiple microphones, according to an embodiment of the invention.

The headphone 201 also includes the DSP 208 that has been modified to generate a noise-masking signal (e.g., the noise-masking signal 110 shown in FIG. 1) that compensates for distracting sounds (e.g., the distracting sounds 108 shown in FIG. 1).

A small body of dynamic masking instructions 209 direct the DSP 208 in carrying out its noise-masking tasks, according to an embodiment of the invention. The instructions 209 may comprise a small register holding instructions for detecting distracting sounds and covering them over with dynamic noise-masking sounds, according to an embodiment of the invention. The instructions 209 could be incorporated into the DSP 208, according to an alternative embodiment of the invention. For some models of headsets 201, the instructions 209 could comprise software that can be added to the headset, e.g., in the case of headsets whose operating instructions are capable of being updated, according to an embodiment of the invention. Thus, the instructions 209 may be electronically accessible and provided to the DSP 208, according to an embodiment of the invention. The electronic accessibility of the instructions 209 may include application of a CPU in some embodiments of the invention.

The DSP 208 receives a signal corresponding to the sounds detected by the microphone 206. As directed by the instructions 209, the DSP 208 filters out from the received signal any sounds that may be useful (e.g., spoken commands by the headset wearer) and processes these sounds in the conventional manner. The DSP 208 checks for distracting sounds in the received signal.

Where the DSP 208 detects distracting sounds (e.g., the distracting sounds 108 shown in FIG. 1), then the DSP 208 generates a compensatory noise-masking sound. The compensatory noise-masking sound generated by the DSP 208 masks the distracting sound with a noise that will not typically be distracting to a wearer of the headphone 201, according to an embodiment of the invention. Suitable compensatory sounds include the sound of wind and/or water, according to an embodiment of the invention.

Suitable compensatory sounds generated by the DSP 208 include the sound of wind and/or water, according to an embodiment of the invention. In another embodiment of the invention, the compensatory sound would be one that simply masks the distracting sound (e.g., the distracting sound 108) without itself being perceptible, e.g., via a sound that masks the distracting sound by reducing it as a rate of level change that would be so slow as to be imperceptible to the average user, but fast enough to account for significant changes in level throughout the day.

The headphone 201 includes speakers 202, 204. As discussed in conjunction with FIG. 1, the speakers 202, 204 may be conventional headphone speakers. The speakers 202, 204 receive from the DSP 208 a compensatory signal (e.g., the noise-masking signal 110 shown in FIG. 1) designed to counter distracting sounds detected by the microphone 206, according to an embodiment of the invention. The speakers 202, 204 provide the compensatory sound directly to the wearer of the headset. The speakers 202, 204 may also include drivers (not shown), such as the drivers 103a, 104a shown in FIG. 1.

Additional masking noise with possibly improved user comfort may be provided by including a masking noise filter 211, according to an embodiment of the invention. The masking noise filter 211 employs a three-dimensional simulation using a well-known technique called “Head Related Transfer Function” (HRTF) which adds the element of simulating for the user the masking noise as a sound external to the headset 201.

The masking noise filter 211 may simulate the experience of having the external the masking noise (e.g., the masking noise 110 shown in FIG. 1) appear to be generated from the room in which the user resides (e.g., such as with masking noise generated by speakers in the ceiling or walls) rather than from the headset 201 (although the masking noise comes from the headphone 201). The masking noise filter 211 accomplishes this effect without the need for the installation of external speakers. Masking noise generation may be effective due to being very intimate to the user, and also controllable to the individual's needs, according to an embodiment of the invention. Thus, the HRTF provided by the masking noise generation filter 211 further enhances the perceived effect of noise masking, according to an embodiment of the invention.

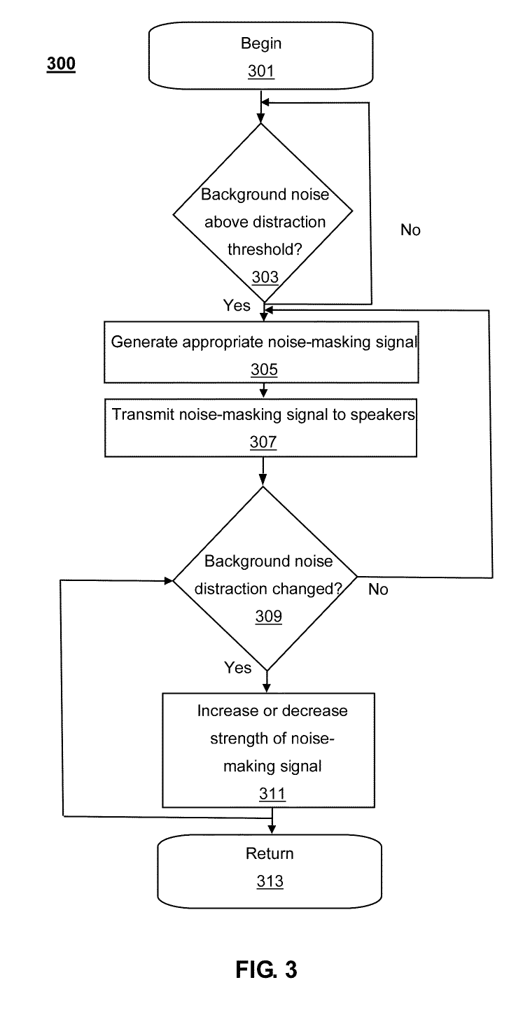

FIG. 3 provides a flowchart 300 for a dynamic noise masking system in a headphone, according to an embodiment of the invention. A digital signal processor (e.g., the DSP 208 shown in FIG. 2) receives sounds sampled from the ambient environment around the headphone. The sounds may be sampled by the headphone's own microphone, or a special microphone could be employed, according to various embodiments of the invention. The headset may include more than one microphone, and in such cases the DSP may need alteration to accommodate multiple microphones, according to an embodiment of the invention.

The DSP in conjunction with a set of dynamic masking instructions (e.g., the dynamic masking instructions 209 shown in FIG. 2) determines 303 if the sounds are above a distraction threshold (e.g., too distracting), such as people talking or the clicking of keys on a computerized keyboard. If the sounds are not too distracting according to the DSP's threshold levels, then the DSP returns to a check for newly received sounds.

If the DSP as directed by the dynamic masking instructions finds the sampled sounds too distracting, according to various thresholds, then the DSP generates 305 an appropriate noise-masking signal. The DSP then transmits 307 the noise-masking signal to speakers associated with the headphones.

The DSP generates the dynamic noise-masking signal by portioning undesired sound into time-blocks and estimates frequency spectrum and power level, and continuously generates a masking noise with a matching spectrum and power level to mask the undesired sound, according to an embodiment of the invention.

The DSP continues to receive sounds from the microphone and determine if they are too distracting, according to an embodiment of the invention.

The DSP determines 309 if the dynamic noise-masking sound needs to be altered (e.g., from time block to time block) because the background noise distraction has changed. If the distracting sound is not growing in strength or conversely lessening in strength, then the DSP can continue to send the same dynamic noise-masking sound to the headphone's speakers.

If the DSP determines 309 that the dynamic noise-masking sound needs to be altered, then DSP makes an appropriate modification 311 to the dynamic noise-masking sound, either strengthening the sound if the distracting noise has grown or weakening the sound if the distracting noise is less severe than previously, according to an embodiment of the invention.

The DSP then returns to determining if the dynamic noise-masking sound should be altered (e.g., in the next time block analyzed). If the DSP determines that there are no, or nearly no, distracting sounds, then the DSP may stop generating the dynamic noise-masking sound while still continue to sample ambient sounds.

The DSP and related adaptive sound masking instructions portions undesired sound into time-blocks and estimates frequency spectrum and power level, and continuously generates masking noise with a matching spectrum and power level to mask the undesired sound, according to an embodiment of the invention.

While a dynamic masking signal, such as the noise-masking signal 110 shown in FIG. 1 could be more effective at masking dynamic noise, some headset wears might find that a dynamic masking signal itself to be irritating and/or distracting in its own right. Accordingly, a static noise masking signal at the “right” level might serve as a happy medium for some situations, according to an embodiment of the invention.

While tailoring the frequency response curve to the background noise could be effective, the masking noise must also be comfortable enough to not become a distraction in its own right. Subjective testing shows, for example, that while white noise is generally more effective at reducing sentence intelligibility, pink noise is perceived as more comfortable, and brown noise even more so. Pink noise (or 1/f noise or flicker noise) is a signal with a frequency spectrum such that the power spectral density (energy or power per Hz) is inversely proportional to the frequency of the signal. In pink noise, each octave (halving/doubling in frequency) carries an equal amount of noise power. Brownian noise, also known as brown noise or red noise, is the kind of signal noise produced by Brownian motion. Experimental results indicate that subjects can wear headsets with masking noise in the brown spectrum for long periods of time without objection, whereas white noise is often highly objectionable.

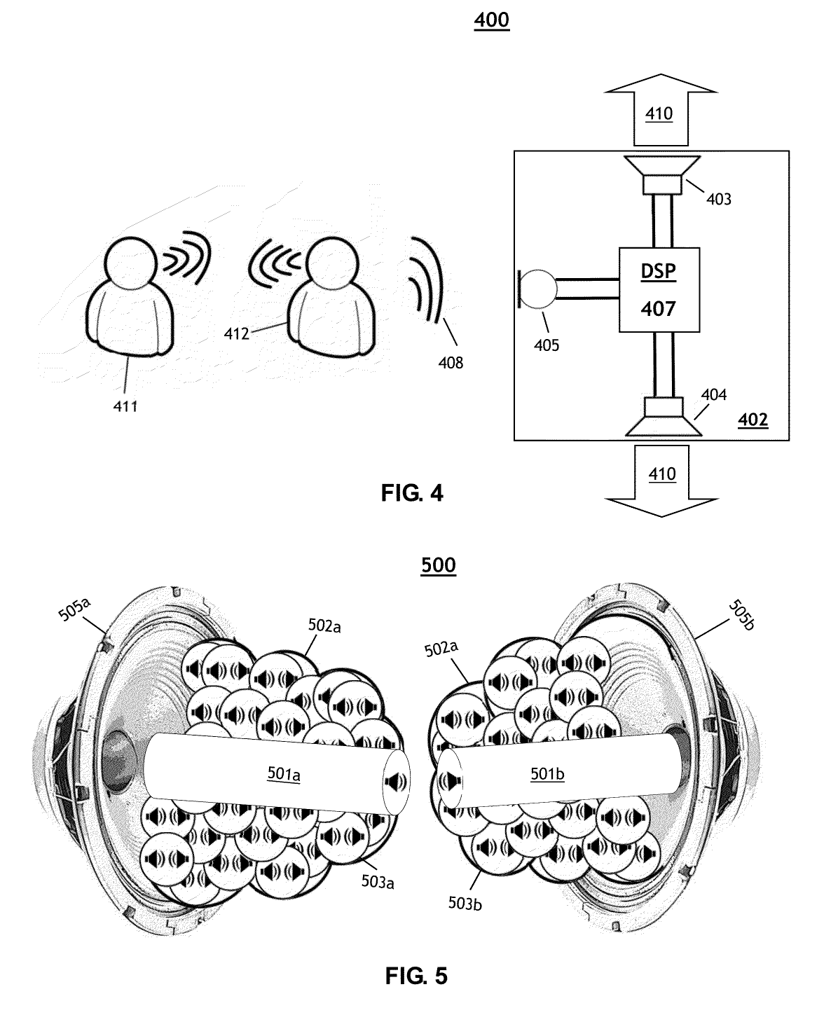

FIG. 4 illustrates a static noise-masking system 400 included in a headset 402, according to an embodiment of the invention. The distracting sounds 408 detected by the microphone 405 have been generated by the activities of persons 411-412, neither of whom is wearing the headset 402.

The headset 402 includes a microphone 405, a digital signal processor 407, and speakers 403, 404, according to an embodiment of the invention. The headset 402 may also include a static noise selector 414, according to an embodiment of the invention. The headset 402 may include more than one microphone, and in such cases the DSP 407 may need alteration to accommodate multiple microphones, according to an embodiment of the invention.

The microphone 405 passes a signal for detected sounds to digital signal processor (DSP) 407 that is particularly tuned to detect sounds 408 that are highly distracting, e.g., human speech.

When the DSP 407 detects the sound 408 at a level judged to be distracting, then the DSP 407 generates a static noise-masking signal 410, according to an embodiment of the invention.

The DSP 407 generates the static noise-masking signal 410 according to a variety of predetermined settings such as low noise, medium noise, and off, according to an embodiment of the invention. The predetermined settings could be application-based or as a switch (e.g., the switch 414) on the headset 402. Giving the headset wearer control over the level of the static noise-masking signal 410 by employing a switch 414 (e.g., a user controllable actuator) could be done as a volume slider rather than at selectable predetermined levels, according to an embodiment of the invention. Generally, however, a headset wearer's attention to and awareness of the masking noise should be minimized, according to experimental results.

Experiments conducted by one of the inventors has shown exemplary results by combining masking noise with a highly occluding headset that also uses active noise cancellation (ANC) performed by the DSP 407, according to an embodiment of the invention.

Introducing the static noise-masking signal 410 into a non-occluding headset 402 (e.g., a non-occluding headset) without ANR is possible, but the level of static noise-masking signal 410 required in such embodiments to significantly reduce speech intelligibility could in some situations be so high that it might be uncomfortable to the user. Accordingly, embodiments of the DSP 407 also practice ANR in conjunction with generating the static noise-masking signal 410.

By reducing the noise otherwise, such as using in-ear inserts or an otherwise highly occluding headset, the static noise-masking signal 410 required to drastically reduce speech intelligibility may actually fairly low.

By performing ANR in the DSP 407, the static noise-masking signal 410 may be reduced still further, according to an embodiment of the invention. A constant, low level static noise-masking signal 410 may be generated by the DSP 407 that is generally not objectionable to most headset users and is effective at masking the sound 408. Embodiments of such headsets may be particular useful for contact center or call center operators and others working in dense environments.

The DSP 407 generates the noise-masking signal 410 in a way that is pleasant and non-disruptive, according to an embodiment of the invention. Speakers 403, 404 in the headset 402 play the noise-masking signal 410 to the headset wearer, according to an embodiment of the invention. The speakers 403, 404 may have drivers (e.g., like the drivers 103a, 104a shown in FIG. 1) that control or direct the sound output of the speakers 403, 404, according to an embodiment of the invention.

As the distracting sound 408 increases (e.g., someone talking close by), so the DSP 407 may shift to a higher predetermined noise-masking signal 410, following the amplitude and frequency response of the distracting sound 408, according to an embodiment of the invention 408. The DSP 407 would tend to produce the static noise-masking signal 410 with a wider broad band spectrum (e.g., a wide spectrum noise), according to an embodiment of the invention.

The static noise-masking signal 410 generated by the DSP 407 is masking noise, in the sense that the static noise-masking signal 410 is wide-spectrum noise, random, with no useful content, and not distracting, according to an embodiment of the invention. As discussed above, the noise-masking signal most typically comprises a wide spectrum noise (e.g., filtered pink or brown noise), according to various embodiments of the invention.

The static noise-masking signal 410 essentially replaces a meaningful (but unwanted) sound (e.g., human speech) with a useless (and hence less distracting) noise, the static noise-masking signal 410. The DSP 407 automatically fades the noise-masking signal 410 back down to silence when the ambient noise abated, according to an embodiment of the invention.

A wearer of the headset 402 would hear something like waves crashing in the ocean or wind in the trees (e.g., both representing the noise-masking signal 410), instead of someone talking (e.g., the distracting sound 408), according to an embodiment of the invention. In another embodiment of the invention, the wearer of the headset 402 would not hear a sound like waves or winds but would instead find the distracting sound 408 reduced, as the rate of level change would, in such an embodiment, be so slow as to be imperceptible to the average user, but fast enough to account for significant changes in level throughout the day.

The DSP 407 ensures that the static noise-masking signal 410 remains dynamic and changes as needed, but does not take someone's attention away, according to an embodiment of the invention.

The static noise-masking system 400 could be implemented in many models of headsets, according to an embodiment of the invention. For example, the static noise-masking system 400 could employ existing microphones in a headset. In other words, the microphone 405 could be an existing microphone in the headset 102. As mentioned above, the system 400 might employ more than one microphone. Similarly, the DSP 407 could be a DSP already resident in the headset 402, according to an embodiment of the invention. Likewise, the speakers 403, 404 could be speakers already resident in the headset 402 and would not necessarily need to be new speakers, according to an embodiment of the invention.

Embodiments of the invention may be particularly applicable to binaural headsets but the headsets would likely not need to be occluding or large.

The static noise-masking system 400 may provide an always-on noise-masking system in the headset 402, so that the headset 402 could be worn all day, to block out distracting noise. The noise-masking system 400 could be active regardless of whether the headphones 402 were in use for another purpose, but would adapt to the situation for music or telephone calls, according to an embodiment of the invention.

The DSP 407 could reduce the noise-masking signal 410 when the user removes the headset 402 and increase the noise-masking signal 410 at a defined rate when the headset 402 is re-donned by the user, so as not to be jarringly obvious to the user, according to an embodiment of the invention.

In an embodiment of the headset 402 where in the headset 402 may also process calls or headset-wearer oral communications, the DSP 407 may be configured to use a different predetermined static noise-masking signal 410 than when the headset 402 is not in use as a communication device, according to an embodiment of the invention. Specifically, the DSP 407 may set the static noise-masking signal 410 at a low level or off when calls are not in process and the static noise-masking signal 410 rises when calls are in process, according to an embodiment of the invention. This embodiment of the headset 402 would be effective in masking speech when on calls, but might not be used or possibly used at low levels for solitary work performed when not on a call, according to an embodiment of the invention. Another embodiment of the headset 402 would leave the masking level constant regardless of call status in order to better fade out of awareness and aid in solitary non-call work as well.

In one embodiment, the DSP 407 directs the static noise-masking signal 410 to play in stereo through the speakers 403, 404 but, when a call occurs in the headset 402, then the incoming speech signal to the speakers 403, 404 is played in monotone. This embodiment enables the user to unconsciously separate the masking noise from the incoming speech signal and reduces any masking of the desired incoming speech signal, according to an embodiment of the invention.

FIG. 5 illustrates a pair of speakers 505a-505b in a headphone 500 that collectively output a mix of stereo masking sounds 502a-502b and monotone call sounds 501a-501b, according to an embodiment of the invention.

As discussed in FIG. 4, the DSP 407 may direct that when a call occurs that the headset (e.g., the 402 shown in FIG. 4) output the call signal in monotone with the masking noise output in stereo, according to an embodiment of the invention.

FIG. 5 provides a stylized view of how each speaker 505a, 505b in a headset 500 outputs a cloud 502a, 502b of stereo masking sounds 503a, 503b while the call signals 501a, 501b are output in monotone, according to an embodiment of the invention.

Combining a stereo masking noise, such as the stereo masking cloud 502a, 502b with a monotone call signal 501a, 501b, prevents the masking noise from interfering with the call signal. Otherwise, the masking noise may mask the call signal, possibly rendering the overall system is useless when the user is taking calls, according to an embodiment of the invention.

The speakers 501a, 501b need not be modified, as the combining of the signals occurs prior to their delivery to the speakers 501a, 501b. Similarly, the regions shown as being stereo and the regions shown as being monotone are purely for illustrative purposes.

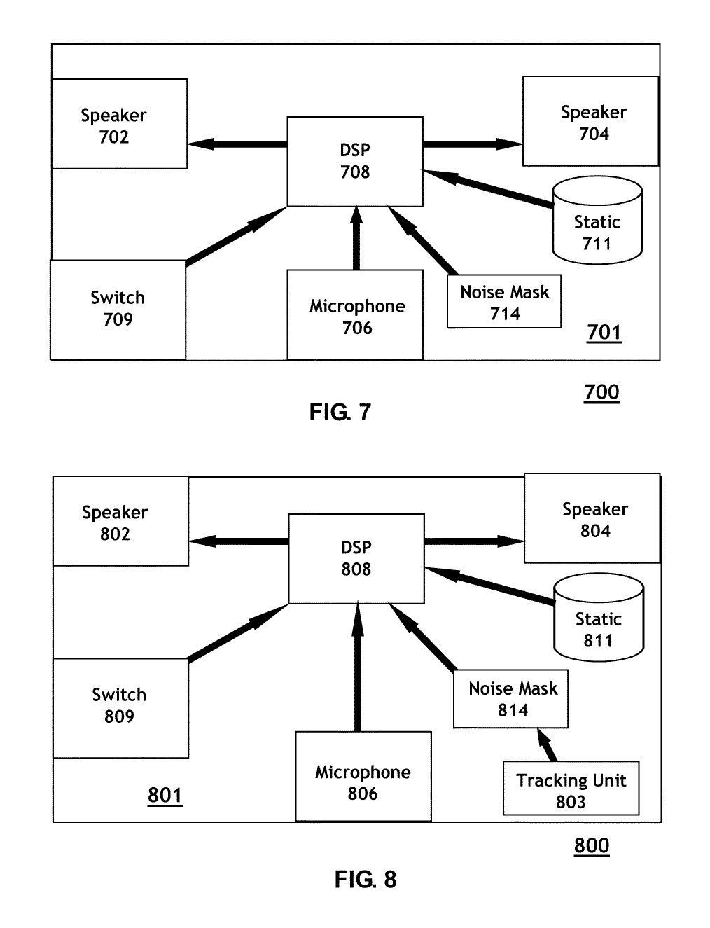

The headset 500 includes the components shown in embodiments such as those of FIG. 2 and FIG. 7, such as a microphone, a DSP, and masking instructions.

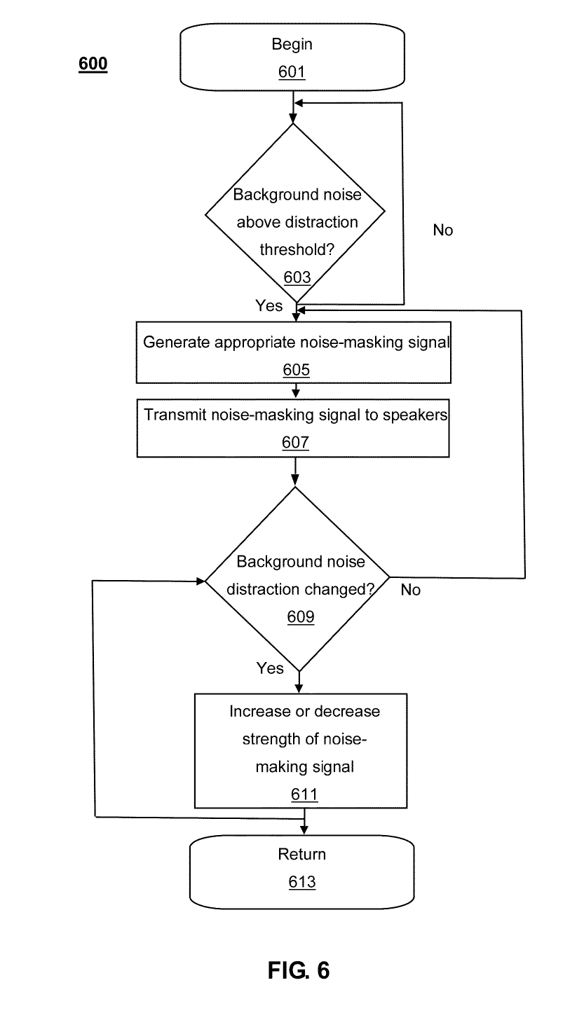

FIG. 6 provides a flowchart 600 that illustrates the operations of static noise-masking system, in a headphone, according to an embodiment of the invention. A digital signal processor (e.g., the DSP 408 shown in FIG. 4) receives sounds sampled from the ambient environment around the headphone. The sounds may be sampled by the headphone's own microphone, or a special microphone could be employed, according to various embodiments of the invention. As mentioned above, the noise-masking system may include more than one microphone, and in such cases the DSP may need alteration to accommodate multiple microphones, according to an embodiment of the invention.

The DSP in conjunction with static masking instructions (e.g., the static masking instructions 711 shown in FIG. 7) determines 603 if the sounds are too distracting, such as people talking or the clicking of keys on a computerized keyboard. If the sounds are not too distracting according to the DSP's threshold levels, then the DSP returns to a check for newly received sounds.

If the DSP as directed by the static masking instructions finds the sampled sounds above a background noise threshold (e.g., too distracting), then the DSP generates 605 a static noise-masking signal. The static noise-masking signal is determined on the basis of a series of predetermined thresholds that relate to the strength of the signal generated, according to an embodiment of the invention. Alternatively, the predetermined thresholds may be selected by a user of the headphones, according to an embodiment of the invention.

The DSP generates the static noise-masking signal by portioning undesired sound into time-blocks and estimates frequency spectrum and power level, and continuously generates a masking noise with a matching spectrum and power level to mask the undesired sound, according to an embodiment of the invention.

The DSP then transmits 607 the static noise-masking signal to speakers associated with the headphones.

The DSP continues to receive sounds from the microphone and determine if they are too distracting, according to an embodiment of the invention.

The DSP determines 609 if the static noise-masking sound needs to be altered, e.g., from time block to time block. If the distracting sound is not growing in strength or conversely lessening in strength, then the DSP can continue to send the same static noise-masking sound to the headphone's speakers.

If the DSP determines 609 that the static noise-masking sound needs to be altered, then DSP makes an appropriate modification 611 to the static noise-masking sound, either strengthening the sound if the distracting noise has grown or weakening the sound if the distracting noise is less severe than previously, according to an embodiment of the invention.

The DSP then returns to determining if the static noise-masking sound should be altered, e.g., in the next time block analyzed. If the DSP determines that there are no, or nearly no, distracting sounds, then the DSP may stop generating the dynamic noise-masking sound while still continue to sample ambient sounds.

In another example, a static sound masking system and method portions undesired sound into time-blocks and estimates frequency spectrum and power level, and continuously generates masking noise with a matching spectrum and power level to mask the undesired sound, according to an embodiment of the invention.

FIG. 7 illustrates a block diagram for a static noise-masking system 700 incorporated into a headphone 701, according to an embodiment of the invention. The headset 702 is a binaural headset (speakers 702, 704).

The headphone 701 includes a microphone 706. As discussed in conjunction with the microphone 405 in FIG. 4, the microphone 706 may be a conventional microphone. The microphone 706 may comprise a microphone boom or a multi-microphone array. The headset 701 may include more than one microphone 706, and in such cases the DSP 708 may need alteration to accommodate multiple microphones, according to an embodiment of the invention.

The microphone 706 detects environmental sounds and forwards them to a digital signal processor 708. Not all of the sounds detected by the microphone 706 will necessarily be distracting sounds. The headset 701 may include more than one microphone, and in such cases the DSP 708 may need alteration to accommodate multiple microphones, according to an embodiment of the invention.

A body of static masking instructions 711 directs the DSP 708 in carrying out its noise-masking tasks, according to an embodiment of the invention. The instructions 711 may comprise a register holding instructions for detecting distracting sounds and covering them over with dynamic noise-masking sounds, according to an embodiment of the invention. The instructions 711 could be incorporated into the DSP 708. For some models of headsets 701, the instructions 711 could comprise software that can be added to the headset, e.g., in the case of headsets whose operating instructions are capable of being updated, according to an embodiment of the invention. Thus, the instructions 711 may be electronically accessible and provided to the DSP 708, according to an embodiment of the invention. The electronic accessibility of the instructions 711 may include application of a CPU in some embodiments of the invention.

The headphone 701 also includes a DSP 708 that has been modified by the instructions 711 to generate a noise-masking signal (e.g., the static noise-masking signal 410 shown in FIG. 4) that compensates for distracting sounds (e.g., the distracting sounds 408 shown in FIG. 4). The DSP 708 employs active noise cancellation (ANC) as a way to improve upon the masking signal generated, according to an embodiment of the invention. Thus, the DSP 708 may be implemented within the context of an occluding, ANR headset 701, having a long boom and a microphone array 706 (like that of the Voyager Legend), according to an embodiment of the invention. The headset 701 may produce a highly acceptable headset for a contact center or call center agent in a dense, noisy environment.

The DSP 708 receives a signal corresponding to the sounds detected by the microphone 706. The DSP 708 filters out from the received signal any sounds that may be useful (e.g., spoken commands by the headset wearer) and processes those sounds in the conventional manner.

The DSP 708 following the instructions 711 also checks for distracting sounds in the received signal. Where the DSP 708 detects distracting sounds (e.g., the distracting sounds 408 shown in FIG. 4), then the DSP 708 generates a compensatory signal (e.g., the static noise-masking signal 410). The compensatory signal generated by the DSP 708 masks the distracting sound (e.g., the sound 408) and does so with a noise (e.g., the static noise-masking signal 410) that will not typically be distracting to a wearer of the headphone 701, according to an embodiment of the invention. Suitable compensatory sounds include the sound of wind and/or water, according to an embodiment of the invention. As discussed above, the compensatory sound comprises pink and/or brown noise, according to an embodiment of the invention.

In another embodiment of the invention, the wearer of the headset 701 would not hear a compensatory sound like waves or winds but would instead find the distracting sound reduced at a rate of level change that would, in such an embodiment, be so slow as to be imperceptible to the average user, but fast enough to account for significant changes in level throughout the day.

The headphone 701 includes speakers 702, 704. The speakers 702, 704 may be conventional headphone speakers.

The speakers 702, 704 receive from the DSP 708 a compensatory signal designed to counter distracting sounds detected by the microphone 706, according to an embodiment of the invention. The speakers 702, 704 may have been designed to fit into an ear of the user of the headset 701, according to an embodiment of the invention. In the headset 701, the noise masking signal emerges from the speakers 702, 704 and travels directly into the ear of the headphone user.

Additional masking noise with possibly improved user comfort may be provided by including a masking noise filter 714, according to an embodiment of the invention. The masking noise filter 714 employs the well-known three-dimensional simulation technique known as the “Head Related Transfer Function” (HRTF) which adds the element of simulating for the user the masking noise as a sound external to the headset 701.

The masking noise filter 714 may simulate the experience of having the external the masking noise (e.g., the masking noise 110 shown in FIG. 1) appear to be generated from the room in which the user resides, e.g., such as with masking noise generated by speakers in the ceiling or walls. The masking noise filter 714 accomplishes this effect without the need for the installation of external speakers. Masking noise generation may be effective due to being very intimate to the user, and also controllable to the individual's needs, according to an embodiment of the invention. Thus, the HRTF provided by the masking noise filter 714 further enhances the perceived effect of noise masking, according to an embodiment of the invention.

FIG. 8 illustrates a noise-masking system 800 that includes a head-tracking unit 803 in a headset 801, according to embodiment of the invention. The head-tracking unit 803 may make the 3-dimensional effect provided by a masking noise filter 814 seem even more real to the user of the headset 801.

The combination of the head-tracking unit 803 and the masking noise filter 814 employs known techniques in which rotational movements of the user's head controls the perceived direction of sound. Thus, the headset 801 includes techniques that further enhance the perceived effect of noise masking provided by the noise-masking sounds generated by a DSP 808.

The head-tracking device 803 typically comprises a gyroscopic filter and outputs from the head-tracking device control the masking noise filter 814, according to an embodiment of the invention. Head-tracking, such as that provided by the head-tracking device 803 is well known to those skilled in the art, and is not further described here.

Noise masking supplemental to that provided by the DSP 808 may be provided by the masking noise filter 814, according to an embodiment of the invention. The results of this supplemental noise masking may also provide improved comfort for some users, according to an embodiment of the invention.

The masking noise filter 814 employs a three-dimensional simulation using a well-known technique called “Head Related Transfer Function” (HRTF) which adds the element of simulating for the user the masking noise as a sound external to the headset 801.

The masking noise filter 814 may simulate the experience of having the external the masking noise (e.g., the masking noise 110 shown in FIG. 1) appear to be generated from the room in which the user resides, e.g., such as with masking noise generated by speakers in the ceiling or walls. The masking noise filter 814 accomplishes this effect without the need for the installation of external speakers. Masking noise generation may be effective due to being very intimate to the user, and also controllable to the individual's needs, according to an embodiment of the invention. Thus, the HRTF provided by the masking noise filter 814 further enhances the perceived effect of noise masking, according to an embodiment of the invention.

The headphone 801 also includes a microphone 806. As discussed in conjunction with FIG. 1, the microphone 806 may be a conventional microphone. The microphone 806 detects environmental sounds and forwards them to a digital signal processor 808. Not all of the sounds detected by the microphone 806 will necessarily be distracting sounds.

The headphone 801 also includes the DSP 808 which has been modified to generate a noise-masking signal (e.g., the noise-masking signal 110 shown in FIG. 1) that compensates for distracting sounds (e.g., the distracting sounds 108 shown in FIG. 1).

A small body of dynamic masking instructions 809 direct the DSP 808 in carrying out its noise-masking tasks, according to an embodiment of the invention. The instructions 809 may comprise a small register holding instructions for detecting distracting sounds and covering them over with dynamic noise-masking sounds, according to an embodiment of the invention. The instructions 809 could be incorporated into the DSP 808. For some models of headsets 801, the instructions 809 could comprise software that can be added to the headset, e.g., in the case of headsets whose operating instructions are capable of being updated, according to an embodiment of the invention.

The DSP 808 receives a signal corresponding to the sounds detected by the microphone 806. As directed by the instructions 809, the DSP 808 filters out from the received signal any sounds that may be useful (e.g., spoken commands by the headset wearer) and processes those sounds in the normal manner. The DSP 808 checks for distracting sounds in the received signal.

Where the DSP 808 detects distracting sounds (e.g., the distracting sounds 108 shown in FIG. 1), then the DSP 808 generates a compensatory sound. The compensatory sound generated by the DSP masks the distracting sound and does so with a noise that will not typically be distracting to a wearer of the headphone 801, according to an embodiment of the invention. Suitable compensatory sounds include the sound of wind and/or water, according to an embodiment of the invention.

The headphone 801 also includes speakers 802, 804. As discussed in conjunction with FIG. 1, the speakers 802, 804 may be conventional headphone speakers. The speakers 802, 804 receive from the DSP 808 a compensatory signal (e.g., the noise-masking signal 110 shown in FIG. 1) designed to counter distracting sounds detected by the microphone 806, according to an embodiment of the invention. The speakers 802, 804 provide the compensatory sound directly to the wearer of the headset. The speakers 802, 804 may also include drivers (not shown), such as the drivers 103a, 104a shown in FIG. 1.

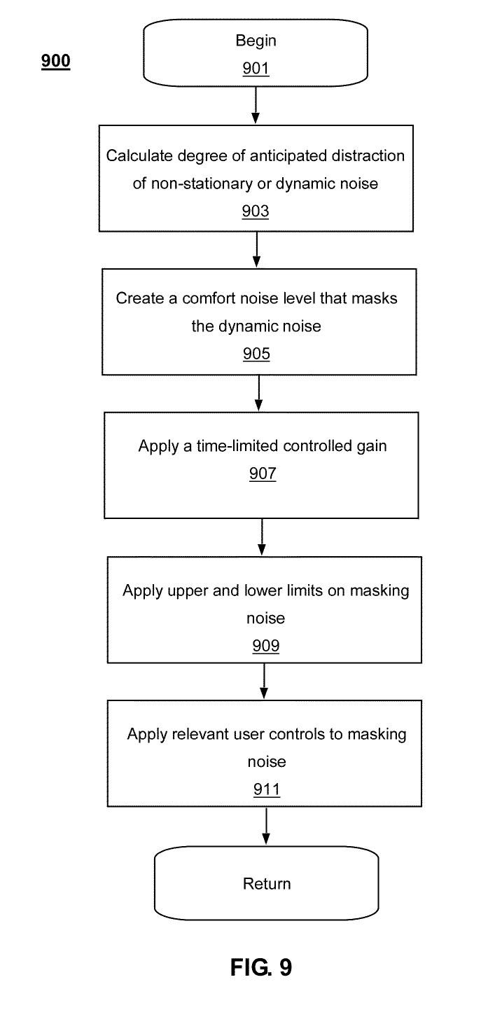

FIG. 9 illustrates a flowchart 900 that provides a noise masking algorithm such as one that could be employed by a digital signal processor, such as the DSP 208 shown in FIG. 2, according to an embodiment of the invention.

The DSP calculates 903 the degree of anticipated distraction due to nearby non-stationary or dynamic noise using known techniques, such as correlation, thresholds and crest factor, and then combines these elements together.

The DSP applies the degree of distraction calculated above to create 905 a correct level of masking noise that is sufficiently loud enough to mask the dynamic noise, but not so loud as to create fatigue for the user.

The DSP applies a controlled gain 907 that has time limited changes so that the user is not detecting fast changes in masking noise levels

The DSP applies upper and lower limits 909 that control how loud the masking noise may be. These limits are determined by the design of the listening device (i.e., headset or headphone).

The DSP may apply 911 some user control of the overall noise masking, according to an embodiment of the invention.

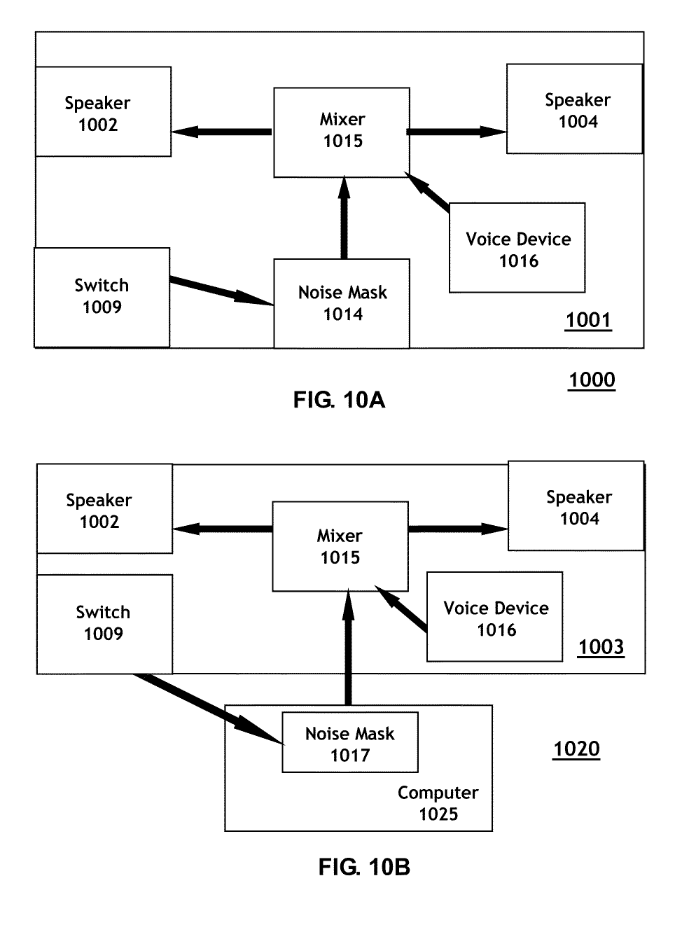

FIG. 10A illustrates a noise-masking system 1000 that comprises a static noise-masking device 1014 in a headset 1001, according to embodiment of the invention. Noise masking in the headset 1001 is static in the sense that the level of noise masking is not set in accordance with ambient conditions but is instead determined by user input.

In the headset 1001, a noise-masking device 1014 produces a stereo noise-masking signal, according to an embodiment of the invention. A mixer 1015 combines the stereo noise-masking signal with a mono call signal from a voice device 1016. The mixer 1015 provides the combined signal to speakers 1002, 1004.

The headset 1001 need not include a microphone or a signal processor as shown in the noise-masking system 100 discussed in FIG. 1. The noise masking provided in the noise-masking system 1000 arises independently of a microphone or signal processor. Of course, a microphone may reside on the headset 1001 to provide outgoing speech signals (e.g., via the voice device 1016), but the microphone does not feed into the noise-masking portion of the headset 1001, according to an embodiment of the invention.

A switch 1009 (e.g., a user controllable actuator) may allow a user to control an amount of noise masking provided by the noise-masking device 1014, according to an embodiment of the invention. The user may set the switch 1009 such that it turns off the noise masking or sets the switch 1009 at various levels (e.g., low, medium, high) of noise masking.

The amount of masking noise for the static noise masking system 1001 subject could vary from a low of about 40 dBspl (A) to a high of about 70 dBspl (A), according to an embodiment of the invention.

The noise-masking device 1014 may provide a stationary (e.g., pink noise) and stereo masking noise on a single channel mono phone call, according to an embodiment of the invention. This embodiment of the invention does not require a signal processor, although implementation may be simplified if one is included.

The inventors have learned that a stereo noise-masking signal can be combined with a mono call signal and the stereo noise-masking signal does not distort the mono call signal but does obscure distracting external sounds.

To provide effective masking, the generated masking noise from the noise-masking device 1014 is uncorrelated between each speaker 1002, 1004, but the desired speech from the voice device 1016 is mono, and correlated, according to an embodiment of the invention. This way the human ear can separate the sounds effectively, and the masking noise does not mask the desired speech.

The noise-masking device 1014 could comprise a number of different hardware devices. For example, the noise-masking device 1014 could comprise two random noise generators that together create two separate, stereo noise channels, which are then filtered to obtain optimum masking characteristics. The noise-masking device 1014 could comprise an analog hardware device or a DSP, according to embodiment of the invention. This can be done either with analog hardware, or a DSP, according to embodiments of the invention.

The voice device 1016 comprises a form of audio transmitter. The voice device 1016 could comprise a device, or a portion of a larger device, that provides output from a softphone, a fixed telephone, a hard-wired telephone, or any other such device the produces audio data. The voice device 1016 could also include inputs from a microphone element in the headset 1001. However, such a microphone in this embodiment of the invention does not provide an input that controls the noise-masking device 1014.

The headset 1001 may include a “Head Related Transfer Function” (HRTF) such as discussed in conjunction with the embodiment of FIG. 7, and the headset 1001 may also include a head-tracking capability such as shown in the head tracking unit 803 shown in FIG. 8.

FIG. 10B illustrates a noise masking system 1020 that comprises a static noise-masking device 1017 in a computer 1025 connected to a headset 1003, according to embodiment of the invention. The noise masking system 1020 is otherwise identical to the noise masking system 1000 shown in FIG. 10A.

The masking noise can be generated in a noise-masking device 1017 that the headset 1003 is connected to, such as a computer 1025 running an application that delivers stereo masking noise to the headset through an interface, such as but not limited to USB. The noise-masking device 1017 could comprise a hardware device, a software device, and/or a hybrid device, according to various embodiments of the invention.

The headset 1003 functions otherwise in accordance with the embodiments of the invention shown in the headset 1001 shown in FIG. 10A.

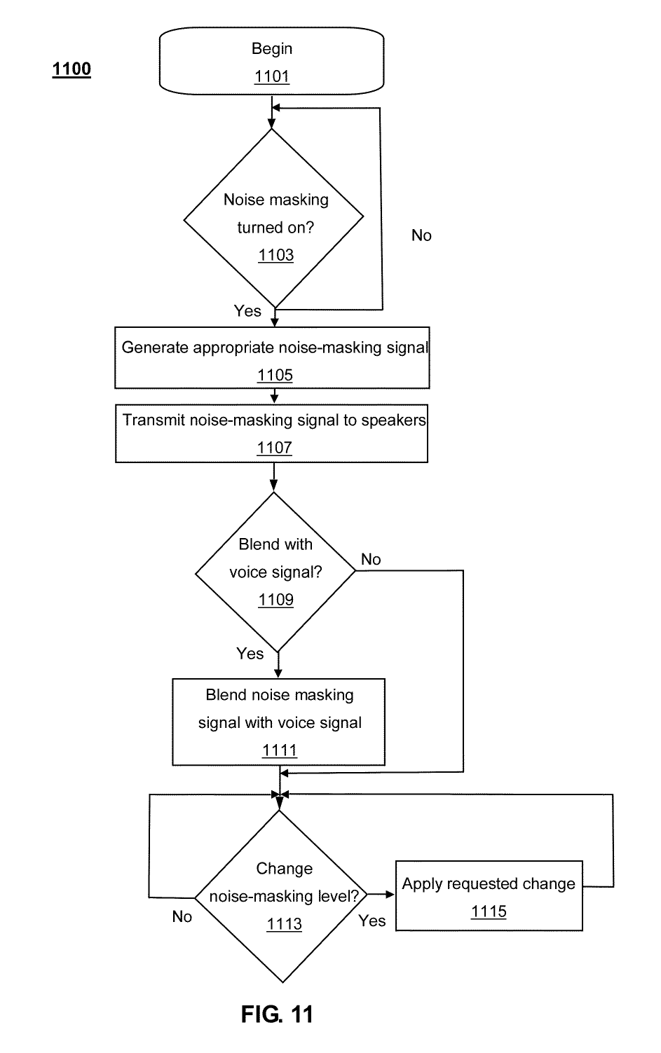

FIG. 11 provides a flowchart 1100 for a static noise masking system in a headphone, such as the headphone 1101 shown in FIG. 10A and the headphone 1103 shown in FIG. 10B, according to an embodiment of the invention.

The headset user may opt to leave noise-masking turned off. If the headset user turns on noise-masking (step 1103), then the noise-masking device determines the level of requested noise masking by the user and generates (step 1105) an appropriate noise-masking signal. Otherwise, the device simply waits to be switched on.

The noise-masking device transmits (step 1105) the noise-masking signal to a pair of speakers in the stereo headset.

The headset user may be engaged in a voice conversation either on a regular telephone, a softphone, or some similar device. If the headset needs to also blend audio voice data with the noise-masking signal (step 1109), then a mixer blends (step 1111) or mixes the stereo noise masking signal with a mono voice data signal. If there is no voice signal to blend with the noise-masking signal, then the noise-masking device determines if the level of masking needs to change (step 1113)

From time-to-time, the user may decide to raise or lower the level of noise-masking. The user may even decide to switch off the noise masking altogether. If the user requests a change in noise masking (step 1113), then the noise-masking device applies (step 115) the requested change. Otherwise, the device continues to check for a change in the level of noise-masking, according to an embodiment of the invention. Alternatively, the device returns to check if there is a voice signal to blend with the noise-masking signal.

If the headset includes a DSP, the DSP may also allow the user to enable or disable the algorithmic control so that a fixed level of noise-masking is obtained, according to an embodiment of the invention. Similarly, the user may be allowed to enable or disable head tracking (if available) and HRTF filters (if available), according to an embodiment of the invention.

Methods and apparatuses for masking open space noise are disclosed. The preceding description has been presented to enable an ordinary artisan in this field to make and use the invention. Descriptions of specific embodiments and applications have been provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein.

Block diagrams of example systems have been illustrated and described for purposes of explanation. The functionality that is described as being performed by a single system component may be performed by multiple components. Similarly, a single component may be configured to perform functionality that is described as being performed by multiple components. For purpose of clarity, details relating to technical material that is known in the technical fields related to the invention have not been described in detail so as not to unnecessarily obscure the present invention. It is to be understood that various example of the invention, although different, are not necessarily mutually exclusive. Thus, a particular feature, characteristic, or structure described in one example embodiment may be included within other embodiments.

While the exemplary embodiments of the present invention are described and illustrated herein, it will be appreciated that they are merely illustrative and that modifications can be made to these embodiments without departing from the spirit and scope of the invention. Acts described herein may be computer readable and executable instructions that can be implemented by one or more processors and stored on a computer readable memory or articles. The computer readable and executable instructions may include, for example, application programs, program modules, routines and subroutines, a thread of execution, and the like. In some instances, not all acts may be required to be implemented in a methodology described herein.

Terms such as “component”, “module”, and “system” are intended to encompass software, hardware, or a combination of software and hardware. For example, a system or component may be a process, a process executing on a processor, or a processor. Furthermore, a functionality, component or system may be localized on a single device or distributed across several devices. The described subject matter may be implemented as an apparatus, a method, or article of manufacture using standard programming or engineering techniques to produce software, firmware, hardware, or any combination thereof to control one or more computing devices.

While specific embodiments of the invention have been illustrated and described, it will be clear that the invention is not limited to these embodiments only. Embodiments of the invention discussed herein have generally been described using Plantronics equipment (e.g., headphones); however, the invention may be adapted for use with equipment from other sources and manufacturers. Equipment used in conjunction with the invention may be configured to operate according to a conventional computer protocol (e.g., USB) and/or may be configured to operate according to a specialized protocol (e.g., a Plantronics serial bus). Numerous modifications, changes, variations, substitutions and equivalents will be apparent to those skilled in the art without departing from the spirit and scope of the invention as described in the claims. In general, in the following claims, the terms used should not be construed to limit the invention to the specific embodiments disclosed in the specification, but should be construed to include all systems and methods that operate under the claims set forth hereinbelow. Thus, it is intended that the invention covers the modifications and variations of this invention provided they come within the scope of the appended claims and their equivalents.

1. A system for masking distracting sounds in a headset comprising:
a microphone in the headset that detects sounds, including distracting sounds;
a signal processor that identifies distracting sounds detected by the microphone and generates a noise-masking signal;
two speakers in the headset that receive the noise-masking signal from the signal processor and play the noise-masking signal.

2. The system of claim 1 wherein the signal processor has been configured to generate the noise-masking signal as a dynamic noise-masking signal whose characteristics are dynamically adapted to correspond to changes in the distracting sound, wherein the dynamic noise-masking signal increases when the distracting sound increases and lessens when the distracting sound lessens.

3. The system of claim 1 wherein the signal processor has been configured to generate the noise-masking signal as a static noise-masking signal whose characteristics are predetermined.

4. The system of claim 3 wherein the static noise-masking signal comprises a set of predetermined static noise-masking signals and wherein the signal processor has been configured to select a static noise-masking signal from the predetermined set of static noise-masking signals corresponding to an intensity of the distracting sound.

5. The system of claim 4 wherein the signal processor has been configured to select another static noise-masking signal from the predetermined set of static noise-masking signals when a characteristic of the distracting sound changes.

6. The system of claim 3 wherein the signal processor also performs active noise cancellation (ANC) in conjunction with generation of the noise-masking signal.

7. The system of claim 1 wherein the noise-masking signal comprises one of pink noise and brown noise.

8. The system of claim 1 further comprising a register comprising a set of dynamic masking instructions that direct the signal processor in the process of detecting the distracting sound and generating the noise-masking signal.

9. The system of claim 1 wherein the noise-masking signal makes a sound resembling at least one of wind and running water.

10. The system of claim 1 wherein the headset further comprises another microphone, wherein the signal processor is configured to receive inputs from two microphones.

11. The system of claim 1 wherein the signal processor generates the noise-masking signal to mask the distracting sound at a rate of level change that is imperceptible to an average wearer of the headset.

12. The system of claim 1 wherein the signal processor generates the noise-masking signal by analyzing ambient noise, and wherein the signal processor retains parameters of the noise masking signal for a fixed time period thereafter.

13. The system of claim 1 wherein the noise-masking signal is a stereo signal and wherein the signal processor is configured to combine the noise-masking signal with a monotone call signal in a manner that preserves the monotone call signal.

14. The system of claim 1 wherein a speaker of the pair of speakers receives one of the noise-masking signal from the signal processor and a call signal.

15. The system of claim 1, further comprising:
a first speaker driver that controls output of the noise-masking signal from the signal processor to a first speaker of the pair of speakers; and
a second speaker driver that controls output of the noise-masking signal from the signal processor to a second speaker of the pair of speakers.

16. The system of claim 1, further comprising:
a noise filter that executes a head-related transfer function that makes the noise-masking signal appear to originate from an external location in a user environment.

17. The system of claim 16, further comprising:
a head tracking unit that follows movement of a headset user's head and controls the head-related transfer function so that the external location for the head-related transfer function follows movement of the user's head.

18.-31. (canceled)

32. A method for masking distracting sounds in a headset comprising:
detecting sounds in a microphone in the headset, including distracting sounds;
identifying distracting sounds in a signal processor from the detected sounds by the microphone and generating a noise-masking signal;
receiving the noise-masking signal in a pair of speakers in the headset from the signal processor and playing the noise-masking signal.

33. The method of claim 32 further comprising generating the noise-masking signal by the signal processor as a dynamic noise-masking signal whose characteristics are dynamically adapted to correspond to changes in the distracting sound, wherein the dynamic noise-masking signal increases when the distracting sound increases and lessens when the distracting sound lessens.

34. The method of claim 32 further comprising generating the noise-masking signal by the signal processor as a static noise-masking signal whose characteristics are predetermined.

35. The method of claim 34 further comprising selecting by the signal processor a static noise-masking signal from the predetermined set of static noise-masking signals corresponding to an intensity of the distracting sound.

36. The method of claim 35 further comprising selecting by the signal processor another static noise-masking signal from the predetermined set of static noise-masking signals when a characteristic of the distracting sound changes.

37. The method of claim 34 further comprising performing active noise cancellation (ANC) by the signal processor in conjunction with generation of the noise-masking signal.

38. The method of claim 32 wherein the noise-masking signal produced by the signal processor comprises at least one of pink noise and brown noise.

39. The method of claim 32 further comprising:
directing the signal processor in the process of detecting the distracting sound and generating the noise-masking signal by a register comprising a set of dynamic masking instructions.

40. The method of claim 32 wherein the noise-masking signal generated by the signal processor makes a sound resembling at least one of wind and running water.

41. The method of claim 32 wherein the headset comprising another microphone and the signal processor is adapted to handle inputs from two microphones.

42. The method of claim 32 wherein the noise-masking signal masks the distracting sound at a rate of level change that is imperceptible to an average user of the headset.

43. The method of claim 32, further comprising:
generating the noise-masking signal by the signal processor by analyzing ambient noise;
initializing the noise-masking signal by the signal processor by dynamically creating the noise-masking signal; and
retaining parameters of the noise-masking signal by the signal processor for a fixed time period.

44. The method of claim 32, wherein the noise-masking signal is a stereo signal, the method further comprising:
combining the noise-masking signal with a monotone call signal by the signal processor in a manner that preserves the monotone call signal.

45. The method of claim 32, further comprising:
receiving the noise-masking signal from the signal processor and a call signal in a speaker of the pair of speakers.

46. The method of claim 32, further comprising:
controlling output of the noise-masking signal from the signal processor to a first speaker of the pair of speakers by a first speaker driver; and
controlling output of the noise-masking signal from the signal processor to a second speaker of the pair of speakers by a second speaker driver.

47. The method of claim 32, further comprising:
executing a head-related transfer function that makes the noise-masking signal appear to originate from an external location in a user environment by a masking noise filter.

48. The method of claim 32, further comprising:
following movement of a headset user's head by a head tracking unit; and
controlling the head-related transfer function by the head tracking unit so that the external location for the head-related transfer function follows movement of the user's head.

49.-62. (canceled)
